(19) United States
(12) Patent Application Publication
(10) Pub. No.: US 2026/0253803 A1
(43) Pub. Date: Aug. 27, 2026

(54) MULTILAYER CERAMIC CAPACITOR

(71) Applicant: Murata Manufacturing Co., Ltd., Nagaokakyo-shi (JP)

(72) Inventors: Kentaro FUJIWARA, Nagaokakyo-shi (JP); Kazunori USUI, Nagaokakyo-shi (JP)

(21) Appl. No.: 19/650,842

(22) Filed: Apr. 17, 2026

Related U.S. Application Data
(63) Continuation of application No. PCT/JP2024/023952, filed on Jul. 2, 2024.

(30) Foreign Application Priority Data
Oct. 25, 2023 (JP) 2023-183261

(51) Int. Cl. H01G 4/232; H01G 4/30

(52) U.S. Cl. CPC H01G 4/2325; H01G 4/30

(57) ABSTRACT

A multilayer ceramic capacitor includes a multilayer body and outer electrodes. The multilayer body includes inner electrodes and dielectric layers alternately laminated. Each of the outer electrodes includes a Ni plating layer, a connected portion and principal-surface folded portions, the connected portion being connected to the inner electrodes, the principal-surface folded portions extending on principal surfaces of the multilayer body. A dimension in the lamination direction is smaller than a dimension in the length direction and a dimension in the width direction. The Ni plating layer in the principal-surface folded portions includes a portion thinner than the Ni plating layer in the connected portion, and a thickness of a thinnest portion of the Ni plating layer in the principal-surface folded portions is about 24% or more and about 74% or less of a thickness of the Ni plating layer in the connected portion.

### CROSS REFERENCE TO RELATED APPLICATIONS

This application claims the benefit of priority to Japanese Patent Application No. 2023-183261 filed on Oct. 25, 2023 and is a Continuation Application of PCT Application No. PCT/JP 2024/023952 filed on Jul. 2, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

As a multilayer ceramic capacitor, for example, there is provided a multi-terminal multilayer ceramic capacitor including a multilayer body and end-surface outer electrodes and side-surface outer electrodes. The multilayer body includes a plurality of dielectric layers having inner electrodes exposed on end surfaces of the multilayer body and a plurality of dielectric layers having inner electrodes exposed on side surfaces of the multilayer body, which are alternately laminated. The end-surface outer electrodes are disposed on the end surfaces, and the side-surface outer electrodes are disposed on the side surfaces. In some of the multilayer ceramic capacitors, the outer electrode includes an underlying electrode layer and a Ni plating layer formed on an outer side portion of the underlying electrode layer (see Japanese Unexamined Patent Application Publication No. 2023-133982).

### SUMMARY OF THE INVENTION

In recent years, electronic devices have been increasingly reduced in thickness. Accordingly, multilayer ceramic capacitors mounted on electronic devices are also required to have a reduced thickness.

Example embodiments of the present invention provide multilayer ceramic capacitors that are further reduced in thickness.

A multilayer ceramic capacitor according to an example embodiment of the present invention includes a multilayer body and outer electrodes. The multilayer body includes inner electrodes and dielectric layers alternately laminated, two principal surfaces on both sides in a lamination direction, two end surfaces on both sides in a length direction intersecting with the lamination direction, and two side surfaces on both sides in a width direction intersecting with the lamination direction and the length direction. The outer electrodes are on the end surfaces or the side surfaces of the multilayer body. Each of the outer electrodes includes a Ni plating layer, a connected portion, and principal-surface folded portions, the connected portion being connected to the inner electrodes, the principal-surface folded portions extending on the principal surfaces. A dimension in the lamination direction is smaller than a dimension in the length direction and a dimension in the width direction. The Ni plating layer in the principal-surface folded portions includes a portion thinner than the Ni plating layer in the connected portion, and a thickness of a thinnest portion of the Ni plating layer in the principal-surface folded portions is about 24% or more and about 74% or less of a thickness of the Ni plating layer in the connected portion.

According to example embodiments of the present invention, multilayer ceramic capacitors are further reduced in thickness.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a schematic perspective view of a multilayer ceramic capacitor 1.

FIG. 2 is a cross-sectional view taken along line II-II in FIG. 1 of a multilayer ceramic capacitor 1 of an example embodiment of the present invention.

FIG. 3 is a cross-sectional view taken along line III-III in FIG. 1 of a multilayer ceramic capacitor 1 of an example embodiment of the present invention.

FIG. 4 is a cross-sectional view along an end-surface-exposed inner electrode 15A of the multilayer ceramic capacitor 1.

FIG. 5 is a cross-sectional view along a side-surface-exposed inner electrode 15B of the multilayer ceramic capacitor 1.

FIG. 6 is an enlarged view of a portion P enclosed by a long dashed double-short dashed line shown in FIG. 2, illustrating a cross-section of an end-surface outer electrode 3C.

FIG. 7 is a diagram for describing a step of producing a multilayer body 2 in an example of a method of producing the multilayer ceramic capacitor 1.

FIG. 8 is a flowchart for describing an example of a method of producing the multilayer ceramic capacitor 1.

### DETAILED DESCRIPTION OF THE EXAMPLE EMBODIMENTS

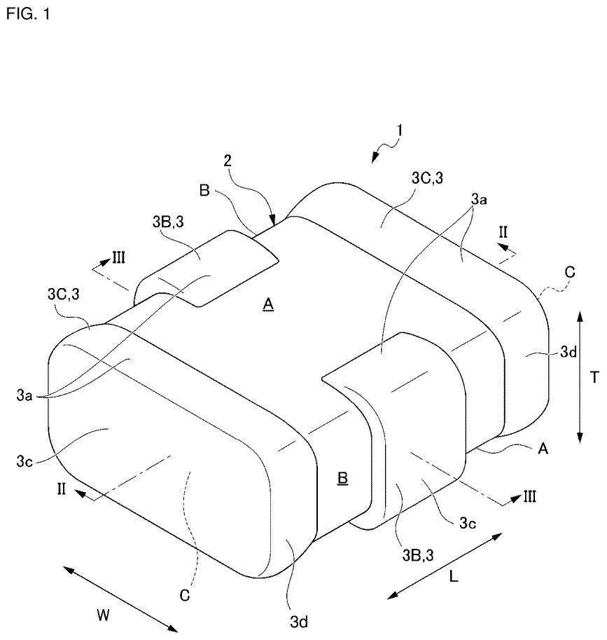

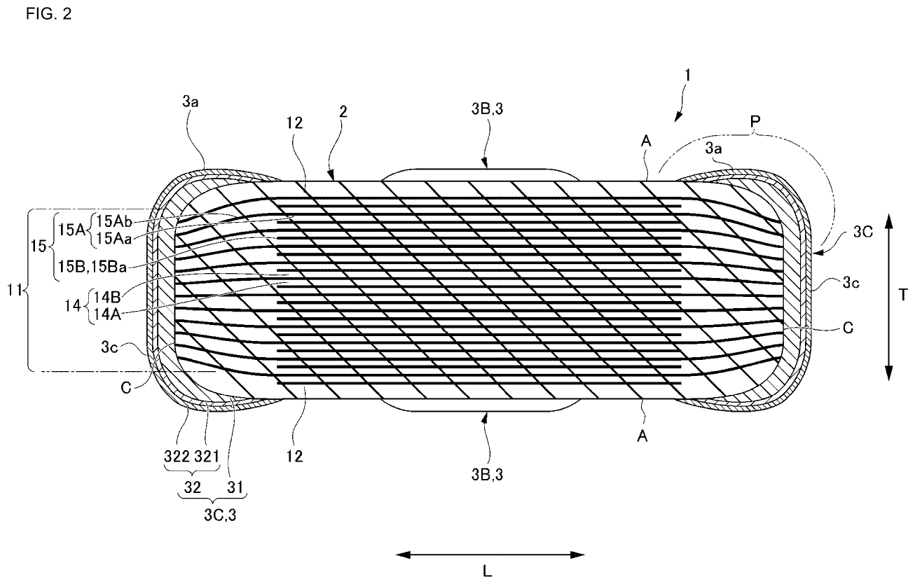

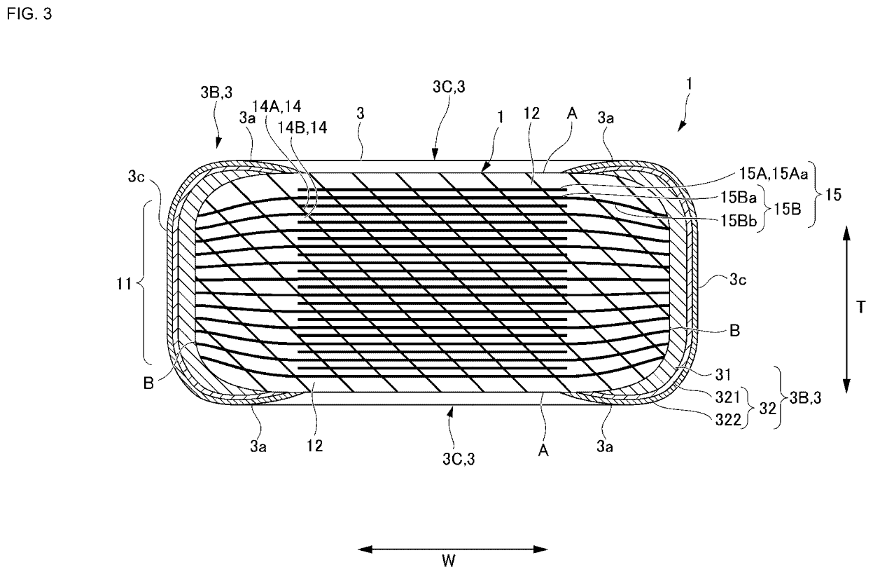

Multilayer ceramic capacitors according to example embodiments of the present invention will be described below. FIG. 1 is a schematic perspective view of the multilayer ceramic capacitor 1. FIG. 2 is a cross-sectional view taken along line II-II in FIG. 1 of the multilayer ceramic capacitor 1 of the present example embodiment. FIG. 3 is a cross-sectional view taken along line III-III in FIG. 1 of the multilayer ceramic capacitor 1 of the present example embodiment.

The multilayer ceramic capacitor 1 includes a multilayer body 2 and outer electrodes 3, and is a three-terminal multilayer ceramic capacitor 1 in which the outer electrodes 3 include end-surface outer electrodes 3C provided on both end surfaces C in a length direction L of the multilayer body 2 and side-surface outer electrodes 3B provided on both side surfaces B in a width direction W of the multilayer body 2. The multilayer body 2 includes an inner layer portion 11 including dielectric layers 14 and inner electrodes 15 laminated on one another, and outer layer portions 12.

In this specification, terms used to denote directions of the multilayer ceramic capacitor 1 are defined as follows. That is, in the multilayer ceramic capacitor 1, the direction in which the dielectric layers 14 and the inner electrodes 15 are laminated is referred to as a lamination direction T. The direction which intersects with the lamination direction T and in which the pair of end-surface outer electrodes 3C are provided is referred to as the length direction L. The direction intersecting with both the length direction L and the lamination direction T is referred to as the width direction W. In the description of example embodiments, the lamination direction T, the length direction L, and the width direction W are orthogonal to each other.

Furthermore, of six external surfaces of the multilayer body 2 in the following description, a pair of external surfaces provided on both sides in the lamination direction T are referred to as principal surfaces A, a pair of external surfaces extending in the lamination direction T and provided on both sides in the width direction W are referred to as side surfaces B, and a pair of external surfaces extending in the lamination direction T and provided on both sides in the length direction L are referred to as end surfaces C.

The multilayer ceramic capacitor 1 is a thin multilayer ceramic capacitor 1 having a dimension in the lamination direction T smaller than a dimension in the length direction L and a dimension in the width direction W. Without limitation, the multilayer ceramic capacitor 1 according to the present example embodiment has a dimension in the length direction L of about 1.20 mm, a dimension in the width direction W of about 0.90 mm, and a dimension in the lamination direction T of about 0.45 mm, for example.

The multilayer body 2 includes the inner layer portion 11 and the outer layer portions 12 disposed on both sides of the inner layer portion 11 in the lamination direction T.

The inner layer portion 11 includes the plurality of dielectric layers 14 and the plurality of inner electrodes 15 laminated along the lamination direction T.

The dielectric layers 14 are made of a ceramic material. For example, a dielectric ceramic including BaTiO₃ as a principal component is used as the ceramic material. Alternatively, a material further including at least one of secondary components such as a Mn compound, an Fe compound, a Cr compound, a Co compound, and a Ni compound in addition to the above-described principal component may be used as the ceramic material.

The inner electrodes 15 are preferably made of a metal material such as Ni, Cu, Ag, Pd, an Ag—Pd alloy, or Au.

The inner electrodes 15 include a plurality of end-surface-exposed inner electrodes 15A and a plurality of side-surface-exposed inner electrodes 15B which are alternately disposed. The end-surface-exposed inner electrodes 15A and the side-surface-exposed inner electrodes 15B are collectively described as the inner electrodes 15 when no distinction is required between them.

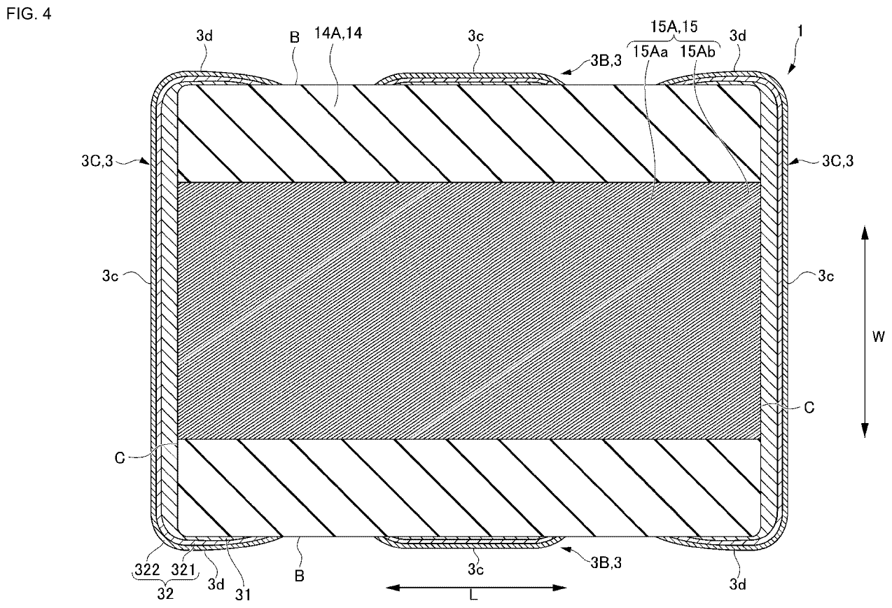

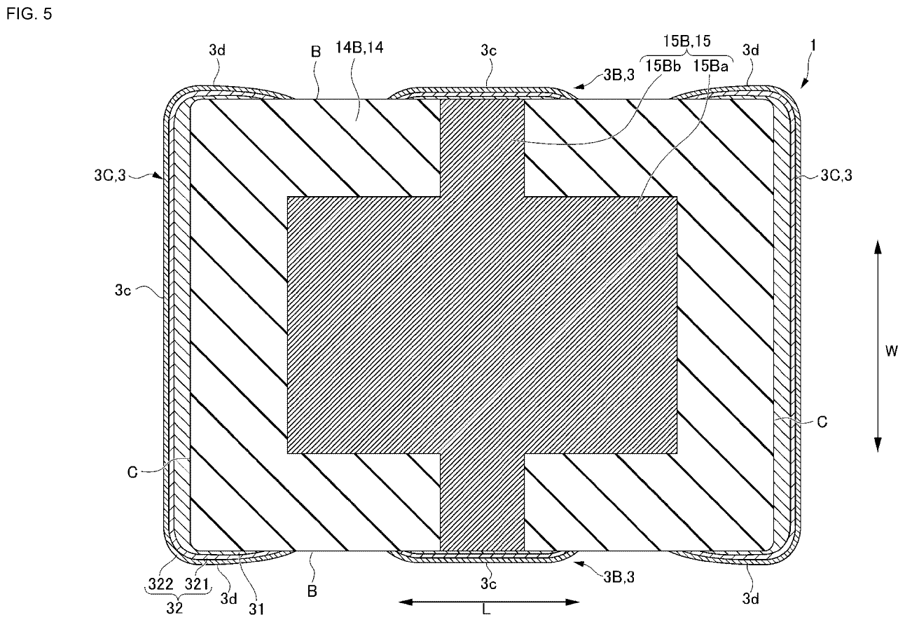

FIG. 4 is a cross-sectional view along an end-surface-exposed inner electrode 15A of the multilayer ceramic capacitor 1. FIG. 5 is a cross-sectional view along a side-surface-exposed inner electrode 15B of the multilayer ceramic capacitor 1.

As illustrated in FIG. 4, the end-surface-exposed inner electrode 15A extends between both end surfaces C in the length direction L of the multilayer body 2, and is spaced apart from both side surfaces B in the width direction W by predetermined distances. The end-surface-exposed inner electrode 15A includes an end-surface opposing portion 15Aa positioned in the central portion between both end surfaces C and end-surface extended portions 15Ab extending from the end-surface opposing portion 15Aa to the end surfaces C on both sides. The end-surface extended portions 15Ab extend to the end surfaces C on both sides and are exposed on the end surfaces C of the multilayer body 2, and are connected to the end-surface outer electrodes 3C provided on both end surfaces C in the length direction L of the multilayer body 2.

As illustrated in FIG. 5, the side-surface-exposed inner electrode 15B is slightly smaller than the multilayer body 2, and is spaced apart from both end surfaces C in the length direction L by predetermined distances. The side-surface-exposed inner electrode 15B includes a side-surface opposing portion 15Ba positioned in the center between both side surfaces B and side-surface extended portions 15Bb extending from the side-surface opposing portion 15Ba to the side surfaces B on both sides. The side-surface extended portions 15Bb extend to the side surfaces B on both sides and are exposed on the side surfaces B of the multilayer body 2, and are connected to the side-surface outer electrodes 3B provided on both side surfaces B in the width direction W of the multilayer body 2.

The end-surface opposing portions 15Aa and the side-surface opposing portions 15Ba are opposed to each other, and define a capacitor. In the following description, the end-surface opposing portions 15Aa and the side-surface opposing portions 15Ba are collectively described as opposing portions 15a when no distinction is required between them. The end-surface extended portions 15Ab and the side-surface extended portions 15Bb are collectively described as extended portions 15b when no distinction is required between them.

The dielectric layers 14 include a plurality of first dielectric layers 14A and a plurality of second dielectric layers 14B which are alternately laminated. The end-surface-exposed inner electrodes 15A exposed on the end surfaces C are disposed on the first dielectric layers 14A, and the side-surface-exposed inner electrodes 15B exposed on the side surfaces B are disposed on the second dielectric layers 14B.

With reference to FIGS. 2 and 3 again, the outer layer portions 12 are dielectric layers having a predetermined thickness and disposed on the principal surface A sides of the inner layer portion 11. The outer layer portions 12 are made of the same material as the dielectric layers 14 in the inner layer portion 11.

Here, in the multilayer body 2, the end-surface opposing portions 15Aa of the first dielectric layers 14A and the side-surface opposing portions 15Ba of the second dielectric layers 14B are laminated so as to overlap one another. However, the end-surface extended portions 15Ab of the first dielectric layers 14A and the side-surface extended portions 15Bb of the second dielectric layers 14B do not overlap one another.

Hence, as illustrated in FIGS. 2 and 3, the portions of the multilayer body 2 where the extended portions 15b are disposed have approximately half the number of inner electrodes 15 as the portion where the opposing portions 15a are disposed, and therefore, the dimension in the lamination direction T (thickness) decreases toward the end surface C or the side surface B.

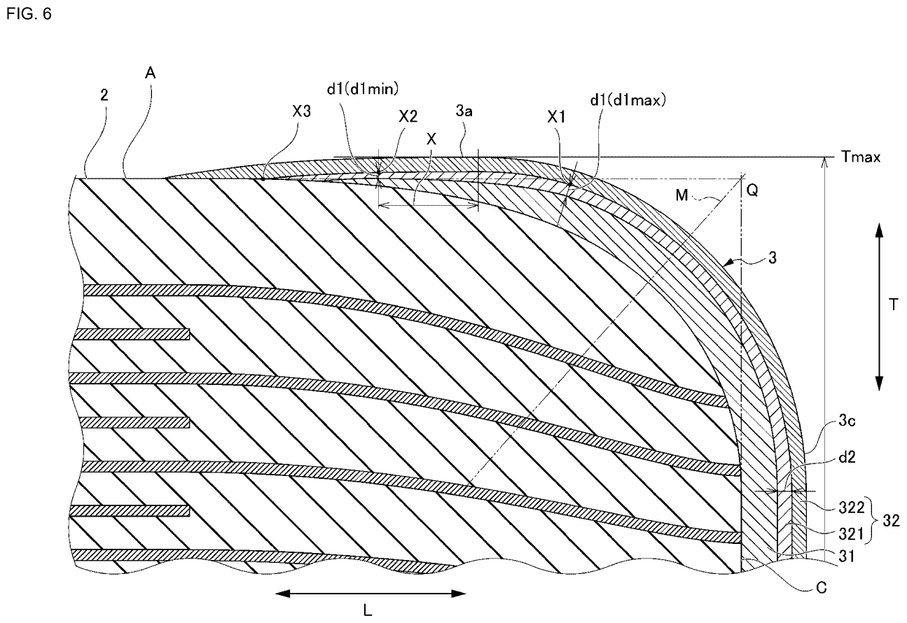

The outer electrodes 3 include the end-surface outer electrodes 3C disposed on both end surfaces C of the multilayer body 2 and the side-surface outer electrodes 3B disposed on both side surfaces B of the multilayer body 2. FIG. 6 is an enlarged view of a portion P enclosed by a long dashed double-short dashed line shown in FIG. 2, illustrating a cross-section of an end-surface outer electrode 3C. The side-surface outer electrodes 3B have a similar configuration, and the end-surface outer electrodes 3C and the side-surface outer electrodes 3B are described as the outer electrodes 3 in the following description when the description is common to them.

Each end-surface outer electrode 3C has a connected portion 3c covering the end surface C and connected to the end-surface extended portions 15Ab of the end-surface-exposed inner electrodes 15A, principal-surface folded portions 3a extending on the principal surfaces A, and side-surface folded portions 3d extending on the side surfaces B.

Each side-surface outer electrode 3B has a connected portion 3c covering the side surface B and connected to the side-surface extended portions 15Bb of the side-surface-exposed inner electrodes 15B, and principal-surface folded portions 3a extending on the principal surfaces A.

In the cross-section illustrated in FIG. 6, the connected portion 3c is defined as a portion on the end surface C side relative to a straight line M, whereas the principal-surface folded portion 3a is defined as a portion on the principal surface A side relative to the straight line M. The straight line M is a line normal to the surface of the multilayer body 2, and passes through an intersection Q between a straight line extended from the principal surface A in the length direction L and a straight line extended from the end surface C in the lamination direction T.

In addition, the outer electrodes 3 include an underlying electrode layer 31 and a plating layer 32 disposed on the underlying electrode layer 31, which applies to both the end-surface outer electrodes 3C and the side-surface outer electrodes 3B. The plating layer 32 includes a Ni (nickel) plating layer 321 disposed on the underlying electrode layer 31 and a Sn (tin) plating layer 322 disposed on the Ni plating layer 321.

In the following description of the thickness of the underlying electrode layer 31, the thickness of the underlying electrode layer 31 is defined as the shortest distance from a point on the lower surface of the underlying electrode layer 31 (the surface bonded to the multilayer body 2) to the outer surface of the underlying electrode layer 31 (the surface bonded to the Ni plating layer 321) in the cross-sectional views illustrated in FIG. 6 and the like. With regard to the Ni plating layer 321 as well, the thickness of the Ni plating layer 321 is defined as the shortest distance from a point on the lower surface of the Ni plating layer 321 (the surface bonded to the underlying electrode layer 31) to the outer surface of the Ni plating layer 321 (the surface bonded to the Sn plating layer 322). With regard to the Sn plating layer 322 as well, the thickness of the Sn plating layer 322 is defined as the shortest distance from a point on the lower surface of the Sn plating layer 322 (the surface bonded to the Ni plating layer 321) to the outer surface of the Sn plating layer 322.

The underlying electrode layer 31 includes, for example, metal and glass. The metal includes at least one selected from, for example, copper, nickel, silver, palladium, a silver-palladium alloy, and gold, and is copper in the present example embodiment. The glass includes, for example, boron and silicon. In the present example embodiment, the thickness of the underlying electrode layer 31 in the connected portion 3c of the side-surface outer electrode 3B is about 21 μm, and the thickness of the underlying electrode layer 31 in the connected portion 3c of the end-surface outer electrode 3C is about 25 μm, for example.

The thickness of the underlying electrode layer 31 in the principal-surface folded portion 3a is smallest at the edge portion facing the center of the principal surface A, and increases toward the end surface C or the side surface B. However, as described earlier, the dimension in the lamination direction T of the multilayer body 2 decreases toward the end surface C or the side surface B. Accordingly, as illustrated in FIG. 6, the contour of the outer surface of the underlying electrode layer 31 curves downward toward the end surface C or the side surface B, while being slightly gentler than the contour of the outer surface of the multilayer body 2.

The Ni plating layer 321 is disposed on an outer side portion of the underlying electrode layer 31. The thickness of the Ni plating layer 321 in the connected portion 3c disposed on the end surface C or the side surface B (connected-portion thickness d2) is substantially uniform, and is about 5 μm in the present example embodiment, for example.

On the other hand, the Ni plating layer 321 in the principal-surface folded portion 3a includes, in order from the end surface C or the side surface B, a thickest portion X1 having a folded-portion thickness d1max, a thinnest portion X2 having a folded-portion thickness d1min, and an end-edge portion X3 on the principal surface A. In the present example embodiment, the folded-portion thickness d1max of the thickest portion X1 of the Ni plating layer 321 in the principal-surface folded portion 3a is substantially equal to the connected-portion thickness d2 of the Ni plating layer 321.

That is, the Ni plating layer 321 in the principal-surface folded portion 3a includes a portion with a folded-portion thickness d1 smaller than the connected-portion thickness d2 of the Ni plating layer 321 in the connected portion 3c. In addition, the folded-portion thickness d1min of the thinnest portion X2 in the principal-surface folded portion 3a is about 24% or more and about 74% or less of the connected-portion thickness d2, for example. That is, without limitation, since the connected-portion thickness d2 of the Ni plating layer 321 is about 5 μm in the present example embodiment, the folded-portion thickness d1min in the thinnest portion X2 is about 1.2 μm or more and about 3.7 μm or less, for example.

However, the contour of the multilayer body 2, even with the underlying electrode layer 31 formed thereon, curves such that the dimension in the lamination direction T decreases toward the end surface C or the side surface B as described above. In the present example embodiment, the thickest portion X1 of the Ni plating layer 321 is disposed in a portion where the contour of the underlying electrode layer 31 curves downward toward the end surface C or the side surface B in the cross-section in FIG. 6. Accordingly, the portion corresponding to the thickest portion X1 of the Ni plating layer 321 does not affect a maximum dimension Tmax in the lamination direction T of the whole multilayer ceramic capacitor 1 (illustrated in FIG. 6).

Note that the portion having the maximum dimension Tmax of the multilayer ceramic capacitor 1 may be positioned at the thinnest portion X2 of the Ni plating layer 321. However, the portion having the maximum dimension Tmax is not necessarily positioned at the thinnest portion X2. In this case, a distance X by which the portion having the maximum dimension Tmax is spaced apart from the thinnest portion X2 is preferably in a range of ±9 μmin the length direction L in the case of the end-surface outer electrode 3C, and is preferably in a range of about ±9 μm, for example, in the width direction W in the case of the side-surface outer electrode 3B.

As illustrated in FIG. 6, the thickness of the Sn plating layer 322 is substantially uniform in the connected portion 3c and in the principal-surface folded portion 3a, and is about 5 μm in the present example embodiment, for example.

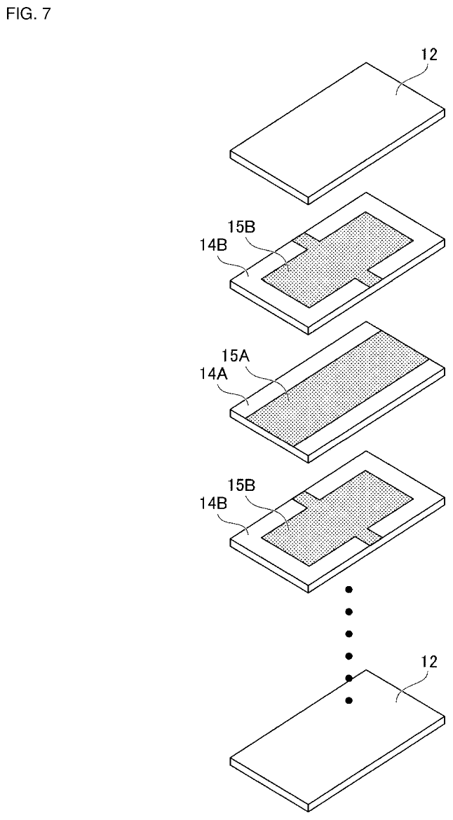

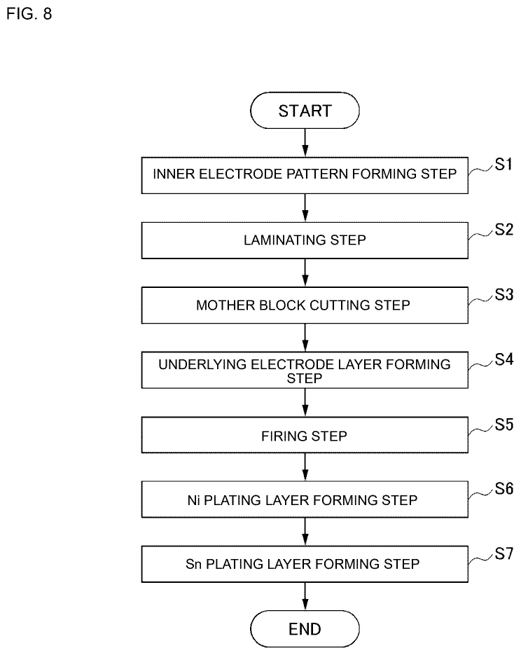

Next, an example of a method of producing the multilayer ceramic capacitor 1 according to the example embodiment will be described. FIG. 7 is a diagram for describing a step of producing the multilayer body 2 in the method of producing the multilayer ceramic capacitor 1. FIG. 8 is a flowchart for describing the method of producing the multilayer ceramic capacitor 1.

A conductive paste is applied to ceramic green sheets, which are to serve as the first dielectric layers 14A, thereby forming the end-surface-exposed inner electrodes 15A. In the same manner, a conductive paste is applied to ceramic green sheets, which are to serve as the second dielectric layers 14B, thereby forming the side-surface-exposed inner electrodes 15B.

The ceramic green sheets are strip-shaped sheets obtained by shaping a ceramic slurry including ceramic powder, a binder, and a solvent into a sheet on a carrier film using a die coater, a gravure coater, a micro-gravure coater, or the like.

The end-surface-exposed inner electrodes 15A and the side-surface-exposed inner electrodes 15B are formed by, for example, screen printing, gravure printing, or letterpress printing.

The ceramic sheets with the end-surface-exposed inner electrodes 15A disposed thereon which are to serve as the first dielectric layers 14A and the ceramic sheets with the side-surface-exposed inner electrodes 15B disposed thereon which are to serve as the second dielectric layers 14B are alternately layered. Subsequently, ceramic green sheets which are to serve as the outer layer portions are disposed on the upper and lower sides, followed by thermocompression bonding, thereby forming a mother block.

Next, the mother block is cut in the length direction L and in the width direction W to be divided, thereby forming a plurality of multilayer bodies 2 having a rectangular parallelepiped shape.

When the outer electrodes 3 are formed, a conductive paste including, for example, copper and glass is first applied on both end surfaces C, thereby forming the underlying electrode layer 31 for the end-surface outer electrodes 3C on both end surfaces C of the multilayer body 2. In this process, the underlying electrode layer 31 for the end-surface outer electrodes 3C is formed so as to cover not only the end surfaces C but also portions of the principal surfaces A and portions of the side surfaces B.

Next, the conductive paste including copper and glass is applied on both side surfaces B, thereby forming the underlying electrode layer 31 for the side-surface outer electrodes 3B on both side surfaces B of the multilayer body 2. In this process, the underlying electrode layer 31 for the side-surface outer electrodes 3B is formed so as to cover not only the side surfaces B but also portions of the principal surfaces A.

Next, the multilayer body 2 with the underlying electrode layer 31 formed thereon is heated at a set firing temperature in a nitrogen atmosphere for a predetermined period of time.

The Ni plating layer 321 is formed by a barrel plating method on the underlying electrode layer 31 baked on the multilayer body 2. The barrel plating method is a method of performing plating while rotating a barrel including conductive media and the multilayer body 2 with the underlying electrode layer 31 formed thereon. In the barrel method, the thickness of the Ni plating layer 321 can be adjusted by controlling the barrel rotation speed, the barrel processing time, the media diameter, and the amount of media.

In the multilayer ceramic capacitor 1 of the present example embodiment, the dimension in the lamination direction T is smaller than the dimension in the length direction L and the dimension in the width direction W. That is, the principal surfaces A are larger than the side surfaces B and the end surfaces C. Thus, adjusting the amount of media can increase the probability of contact between the principal surfaces A of different multilayer bodies 2 during the barrel plating process. As a result, the growth of plating on the principal surfaces A in contact with each other is retarded compared with that on the end surfaces C and the side surfaces B. Accordingly, the plating layers on the principal surfaces A can be made thinner than those on the end surfaces C and the side surfaces B.

In this manner, the Ni plating layer 321 in the principal-surface folded portions 3a can have a portion with a folded-portion thickness d1 smaller than the connected-portion thickness d2. In addition, with regard to the folded-portion thickness d1, the Ni plating layer 321 in the principal-surface folded portions 3a can have, in order from the end surface C or the side surface B, the thickest portion X1, the thinnest portion X2, and the end-edge portion X3.

Furthermore, the folded-portion thickness d1min of the thinnest portion X2 in the principal-surface folded portions 3a can be set to be about 24% or more and about 74% or less of the connected-portion thickness d2, for example. That is, when the connected-portion thickness d2 of the Ni plating layer 321 is about 5 μm, the folded-portion thickness d1min of the thinnest portion X2 in the principal-surface folded portions 3a can be set to be about 1.2 μm or more and about 3.7 μm or less, for example.

The Ni plating layer 321 is formed to prevent the underlying electrode layer 31 from being eroded by solder and from being penetrated by moisture. In order to achieve such effects, the Ni plating layer 321 needs to have at least a thickness sufficient to prevent exposure of the underlying electrode layer 31.

The inner electrodes 15 are exposed on the end surfaces C or the side surfaces B. When the conductive paste including Cu and glass is applied onto the end surfaces C or the side surfaces B on which the inner electrodes 15 are exposed, a large amount of Cu migrates toward the inner electrodes 15 since Cu is more likely to be bonded to the inner electrodes 15 than glass, so that the Cu density increases on the inner electrode 15 side.

As a result, the glass density in the conductive paste on the outer surface side, that is, on the opposite side from the inner electrodes 15, increases, so that glass is likely to emerge on the external surface of the conductive paste. The Ni plating layer 321 is not readily formed on glass. Accordingly, in order to evenly cover the external surface where glass has emerged with the Ni plating layer 321, the Ni plating layer 321 is required to have a certain thickness. This means that the thickness of the Ni plating layer 321 on the end surfaces C or the side surfaces B cannot be significantly reduced.

However, the inner electrodes 15 are not exposed on the principal surfaces A of the multilayer body 2. Accordingly, since the underlying electrode layer 31 formed in the principal-surface folded portions 3a has a substantially uniform glass density as a whole, the likelihood that glass emerges on the external surface is lower than that in the case of the connected portion 3c. Therefore, the Ni plating layer 321 in the principal-surface folded portions 3a is not required to be as thick as the Ni plating layer 321 in the connected portion 3c to evenly cover the whole external surface with the Ni plating layer 321. For example, the continuity of the Ni plating layer 321 in the principal-surface folded portions 3a is ensured as long as the thickness of the Ni plating layer 321 is at least about 0.5 μm or more, for example. As a result, even when the Ni plating layer 321 in the principal-surface folded portions 3a has a portion with a folded-portion thickness d1 smaller than the connected-portion thickness d2 as in the present example embodiment, the underlying electrode layer 31 is not exposed through the Ni plating layer 321.

After the firing of the underlying electrode layer 31, glass-removal polishing may further be performed on the principal surfaces A to reduce the amount of glass that has emerged on the surfaces of the principal-surface folded portions 3a.

After the above process, the Sn plating layer 322 is formed. In the present example embodiment, the Sn plating layer 322 may be formed by the barrel plating method, as in the case of the Ni plating layer 321, or by another method. The Sn plating layer 322 improves wettability of solder on the multilayer ceramic capacitor 1. This facilitates mounting of the multilayer ceramic capacitor 1 onto a substrate or the like.

In the multilayer ceramic capacitor 1 of the present example embodiment described above, the Ni plating layer 321 in the principal-surface folded portions 3a includes a portion with a folded-portion thickness smaller than the connected-portion thickness of the Ni plating layer 321 in the connected portion 3c, and the folded-portion thickness of the thinnest portion X2 in the principal-surface folded portions 3a is about 24% or more and about 74% or less of the connected-portion thickness. Accordingly, when, for example, the thickness in the lamination direction T of the multilayer ceramic capacitor 1 is fixed, the thickness of the inner layer portion 11 can be increased compared with the case where the thickness in the principal-surface folded portions 3a is equal to that in the connected portion.

In the present example embodiment, the thickness of the Ni plating layer 321 in the connected portion 3c is about 5 μm, for example. In addition, the thickness of the thinnest portion X2 of the Ni plating layer 321 in the principal-surface folded portions 3a is about 1.2 μm or more and about 3.7 μm or less, for example.

Here, it is assumed that the folded-portion thickness d1 of the Ni plating layer 321 at the portion having the maximum dimension Tmax in the lamination direction T of the final multilayer ceramic capacitor 1 is, for example, about 2 μm, which is equal or close to the folded-portion thickness d1min of the thinnest portion X2.

In this case, as compared with the case where the folded-portion thickness d1 of the Ni plating layer 321 at the portion having the dimension Tmax is about 5 μm, which is the same as the connected-portion thickness d2 in the connected portion 3c, the thickness of the Ni plating layer 321 can be reduced by about 3 μm on each principal surface, that is, a total of about 6 μm on both principal surfaces, for example.

Therefore, when the thickness in the lamination direction T of the multilayer ceramic capacitor 1 is fixed, the number of inner electrodes 15 can be increased by, for example, about three or four, thus increasing the electrostatic capacitance of the multilayer ceramic capacitor 1.

Although the example embodiments of the present invention have been described above, the present invention is not limited to the example embodiments described above, and various modifications and variations may be made.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including inner electrodes and dielectric layers alternately laminated, two principal surfaces on both sides in a lamination direction, two end surfaces on both sides in a length direction intersecting with the lamination direction, and two side surfaces on both sides in a width direction intersecting with the lamination direction and the length direction; and
outer electrodes on the end surfaces or the side surfaces of the multilayer body, each of the outer electrodes including a Ni plating layer, a connected portion, and principal-surface folded portions, the connected portion being connected to the inner electrodes, the principal-surface folded portions extending on the principal surfaces; wherein a dimension in the lamination direction is smaller than a dimension in the length direction and a dimension in the width direction; and
the Ni plating layer in the principal-surface folded portions includes a portion thinner than the Ni plating layer in the connected portion, and a thickness of a thinnest portion of the Ni plating layer in the principal-surface folded portions is about 24% or more and about 74% or less of a thickness of the Ni plating layer in the connected portion.

2. The multilayer ceramic capacitor according to claim 1, wherein the multilayer ceramic capacitor is a three-terminal capacitor, and the outer electrodes are provided on the end surfaces and the side surfaces.

3. The multilayer ceramic capacitor according to claim 1, wherein the thickness of the thinnest portion is about 1.2 μm or more and about 3.7 μm or less.

4. The multilayer ceramic capacitor according to claim 1, wherein a portion with a largest dimension in the lamination direction of the multilayer ceramic capacitor is positioned in a range of about ±9 μm from the thinnest portion toward the surface on which the connected portion is provided.

5. The multilayer ceramic capacitor according to claim 1, wherein the Ni plating layer in the principal-surface folded portions includes, in order from a side closer to the surface on which the connected portion is provided, a thickest portion, the thinnest portion, and an end-edge portion on a corresponding one of the principal surfaces.

6. The multilayer ceramic capacitor according to claim 1, wherein a thickness in the lamination direction of the multilayer body decreases toward the surface on which the connected portion is provided.

7. The multilayer ceramic capacitor according to claim 1, wherein the multilayer ceramic capacitor has a dimension in the length direction of about 1.20 mm, a dimension in the width direction of about 0.90 mm, and a dimension in the lamination direction of about 0.45 mm.

8. The multilayer ceramic capacitor according to claim 1, wherein each of the outer electrodes includes an Sn plating layer on the Ni plating layer.

9. The multilayer ceramic capacitor according to claim 1, wherein each of the outer electrodes includes an underlying electrode layer on which the Ni plating layer is provided.

10. The multilayer ceramic capacitor according to claim 9, wherein the underlying electrode layer includes metal and glass.

11. The multilayer ceramic capacitor according to claim 9, wherein a thickness of the underlying electrode layer in the connected portion of the outer electrode on one of the side surfaces is less than a thickness of the underlying electrode layer in the connected portion of the outer electrode on one of the end surfaces.

12. The multilayer ceramic capacitor according to claim 9, wherein a thickness of the underlying electrode layer in the connected portion of the outer electrode on one of the side surfaces is about 21 μm and a thickness of the underlying electrode layer in the connected portion of the outer electrode on one of the end surfaces is about 25 μm.

13. The multilayer ceramic capacitor according to claim 9, wherein a thickness of the underlying electrode layer in one of the principal-surface folded portions is smallest at an edge portion facing a center of one of the principal surfaces and increases toward one of the end surfaces or one of the side surfaces.

14. The multilayer ceramic capacitor according to claim 9, wherein a contour of an outer surface of the underlying electrode layer curves downward toward one of the end surfaces or one of the side surfaces.

15. The multilayer ceramic capacitor according to claim 1, wherein a thickness of the Ni plating layer in the connected portion disposed on at least one of the end surfaces and the side surfaces is about 5 μm.

16. The multilayer ceramic capacitor according to claim 1, wherein a thickness of the Ni plating layer in the principal-surface folded portions is about 0.5 μm or more.

17. The multilayer ceramic capacitor according to claim 1, wherein a contour of the multilayer body curves.

18. The multilayer ceramic capacitor according to claim 8, wherein a thickness of the Sn plating layer is about 5 μm.

19. The multilayer ceramic capacitor according to claim 1, wherein a thickness of the principal surface folded-portion of the Ni plating layer at a portion with a maximum dimension is about 2 μm.

20. The multilayer ceramic capacitor according to claim 1, wherein
the outer electrodes are provided on the end surfaces and the side surfaces; and
the inner electrodes include first inner electrodes and second inner electrodes; and
the outer electrodes include first opposing outer electrodes and second opposing outer electrodes; and
both ends of the first inner electrodes are connected to the first opposing outer electrodes; and
both ends of the second inner electrodes are connected to the second opposing outer electrodes.
